(19) United States
(12) Patent Application Publication
(10) Pub. No.: US 2026/0016593 A1
(43) Pub. Date: Jan. 15, 2026

(54) MACHINE LEARNING BASED OBJECT DETECTION FOR TRANSIT SYSTEMS

(71) Applicant: Cubic Transportation Systems, Inc., San Diego, CA (US)

(72) Inventor: Anton Tishchenko, Guildford (GB)

(73) Assignee: Cubic Transportation Systems, Inc., San Diego, CA (US)

(21) Appl. No.: 19/257,370

(22) Filed: Jul. 1, 2025

Related U.S. Application Data
(60) Provisional application No. 63/667,467, filed on Jul. 3, 2024.

(51) Int. Cl. G01S 13/89

(52) U.S. Cl. CPC G01S 13/89

(57) ABSTRACT

Systems and methods for object detection through a fare gate in a transit system is disclosed. The object detection system includes a radar positioned at a first position and a reflective surface positioned at a second position of the fare gate, a machine learning (ML) engine, and a forensic engine. The radar emits a signal and generates a primary clustered point cloud from the signal reflected back from the object in a primary field-of-view (FOV). The reflective surface has a secondary FOV with a secondary clustered point cloud of the object. The ML engine extracts features of the object from the primary clustered point cloud and the secondary clustered point cloud and correlates the features with object profiles. The ML engine further determines that an object profile corresponds with an anomaly and generates a flag. The forensic engine captures media corresponding to the object associated with the flag.

### PRIORITY

This application is a non-provisional of and claims priority to U.S. Provisional Patent Application No. 63/667,467, filed Jul. 3, 2024, the contents of which is incorporated herein by reference in its entirety.

### BACKGROUND

This disclosure relates, in general, to an object detection system and, not by way of limitation, to object detection using machine learning, among other things.

Fare gates are used to regulate entry and exit of a transit system, like metro, subway, or train stations. Fare evasion is a vexing problem posing security threats and affecting revenue of the transit system. The fare gate has to allow valid access efficiently, especially during peak volumes. Riders passing through the fare gates may be accompanied by strollers, luggage, free riding children, or various other objects. Mechanical paddles are actuated for valid riders passing through the fare gates along with allowed objects or children.

The object detection at the fare gates is used to distinguish valid riders from fare evaders or to detect riders accompanied by impermissible objects is complex. Restricted coverage, challenging integration of complex designs, power consumption, and/or viewpoint variations are the common issues during object detection. At times of peak congestion, accurate detection of valid riders avoids unnecessary bottlenecks. Different types of sensors are used to open the mechanical paddles of the fare gates for the valid riders, while keeping them closed to prevent fare evasion.

### SUMMARY

In one embodiment, the present disclosure provides an object detection system to detect an object transiting through a fare gate in a transit system. The object detection system includes a radar positioned at a first position and a reflective surface positioned at a second position of the fare gate, a machine learning (ML) engine, and a forensic engine. The radar emits a signal and generates a primary clustered point cloud from the signal reflected back from the object in a primary field-of-view (FOV). The reflective surface has a secondary FOV with a secondary clustered point cloud of the object. The ML engine extracts features of the object from the primary clustered point cloud and the secondary clustered point cloud, applies prediction-based algorithms and correlates the features with object profiles. The ML engine further determines that an object profile corresponds with an anomaly and generates a flag. The forensic engine captures media corresponding to the object associated with the flag.

In an embodiment, an object detection system to detect an object transiting through a fare gate in a transit system. The object detection system includes a radar positioned at a first position and a reflective surface positioned at a second position of the fare gate. The radar emits a signal at incidence angles and generates a primary clustered point cloud from the signal reflected back from the object in a primary field-of-view (FOV). The reflective surface reflects the signal at reflection angles and has a secondary FOV with a secondary clustered point cloud of the object. The incidence angles and the reflection angles affect an electromagnetic response of the reflective surface. The primary FOV and the secondary FOV are variable based on a position of the radar and a position of the reflective surface as spherical coordinates. The reflective surface is passive and contains copper layers with a substrate in between the copper layers. The reflective surface further includes wavelength-related spatially arranged unit-cell patches with a variable geometry in a phase pattern. A size of the reflective surface is a function of an operational frequency wavelength and transmit power of the radar and an aperture efficiency of the reflective surface that depends on the distance to the radar. The object detection system further includes a machine learning (ML) engine and a forensic engine. The ML engine extracts features of the object from the primary clustered point cloud and the secondary clustered point cloud and correlates the features with object profiles. The ML engine further determines that an object profile corresponds with an anomaly associated with the object and generates a flag upon identifying the anomaly. The forensic engine captures media corresponding to the object associated with the flag.

In another embodiment, an object detection method for detecting an object transiting through a fare gate of a transit system. In one step, the object detection method includes positioning a radar at a first position and positioning a reflective surface at a second position of the fare gate. The radar emits a signal at incidence angles and generates a primary clustered point cloud from the signal reflected back from the object in a primary field-of-view (FOV). The reflective surface reflects the signal at reflection angles and has a secondary FOV with a secondary clustered point cloud of the object. The incidence angles and the reflection angles affect an electromagnetic response of the reflective surface. The primary FOV and the secondary FOV are variable based on a position of the radar and a position of the reflective surface as a plurality of spherical coordinates. The reflective surface is passive and contains copper layers with a substrate in between the copper layers. The reflective surface further includes wavelength-related spatially arranged unit-cell patches with a variable geometry in a phase pattern. A size of the reflective surface is a function of an operational frequency wavelength of the radar and an aperture efficiency of the reflective surface for the selected distance to the radar and its nominal transmit power. The object detection method further includes configuring a machine learning (ML) engine to extract features of the object from the primary clustered point cloud and the secondary clustered point cloud and correlate the features with object profiles. The ML engine further determines that an object profile corresponds with an anomaly associated with the object and generates a flag upon identifying the anomaly. A forensic engine captures media corresponding to the object associated with the flag.

In another embodiment, a machine-readable medium having machine-executable instructions embodied thereon that, when executed by one or more processors, facilitate a method for object detection for detecting an object transiting through a fare gate in a transit system. The method includes positioning a radar at a first position and positioning a reflective surface at a second position of the fare gate. The radar emits a signal at incidence angles and generates a primary point cloud from the signal reflected back from the object in a primary field-of-view (FOV). The reflective surface reflects the signal at reflection angles and has a secondary FOV with a secondary point cloud of the object. The incidence angles and the reflection angles affect an electromagnetic response of the reflective surface. The primary FOV and the secondary FOV are variable based on a position of the radar and a position of the reflective surface as spherical coordinates. The reflective surface is passive and contains copper layers with a substrate in between the copper layers. The reflective surface further includes wavelength-related spatially arranged unit-cell patches with a variable geometry in a phase pattern. A size of the reflective surface is a function of an operational frequency wavelength of the radar and an aperture efficiency. The method further includes configuring a machine learning (ML) engine to extract features of the object from the primary point cloud and the secondary point cloud and correlate the features with object profiles. The ML engine further determines that an object profile corresponds with an anomaly associated with the object and generates a flag upon identifying the anomaly. A forensic engine captures media corresponding to the object associated with the flag.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 illustrates an object detection system to detect an object transiting through a fare gate;

FIG. 2 illustrates a detection workflow via a machine learning (ML) engine;

FIG. 3 illustrates a perspective view of the fare gate with a radar and a reflective surface positioned at the fare gate;

FIG. 4 illustrates a top view of the fare gate with the object transiting through the fare gate;

FIG. 5 illustrates a front sectional view of the fare gate with incidence angles and reflection angles of signals;

FIG. 6A illustrates a front view of the fare gate with a first reflective surface and a second reflective surface positioned at the fare gate;

FIG. 6B illustrates a top sectional view of the fare gate with field-of-views (FOVs);

FIG. 7 illustrates the reflective surface engineered for beam steering at reflection angles; and

FIG. 8 illustrates a detection method for object detection at the fare gate.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

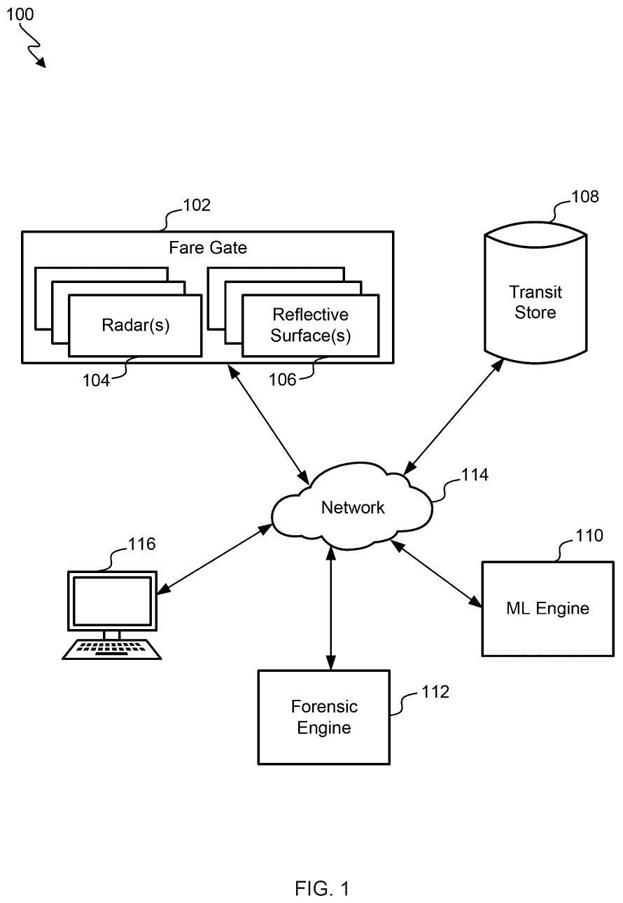

Referring to FIG. 1, an object detection system 100 to detect an object transiting through a fare gate 102 of a transit system is shown as an embodiment. The object detection system 100 tracks fare evasion behaviors of the object as well as anomalies associated with the object at the fare gate 102. The object is a rider or a passenger transiting through the fare gate 102, either alone or accompanied by other objects, such as passengers, luggage, dogs, or weapons. The anomalies include susceptible patterns of the object (passenger), including the presence of impermissible materials, such as the object carrying a gun through the fare gate 102 of an airport checkpoint. The fare gate 102 regulates access to the compensated sections of the transit system. The object detection system 100 tracks a wrong entry or tailgating, where the rider attempts to pass through the fare gate 102 closely behind another rider to get unauthorized access. The object detection system 100 detects riders crawling under or jumping over the fare gate 102, forcing gate paddles, or loitering in the aisle. The object detection system 100 detects the riders transiting through the fare gate 102 with any associated anomalies. The object detection system 100 includes the fare gate 102, a transit store 108, a machine learning (ML) engine 110, a forensic engine 112, a network 114, and a node 116. The object detection system 100 further includes radar(s) 104 and reflective surface(s) 106, positioned on surfaces of the fare gate 102.

The fare gate 102 allows the riders to transit in the transit system when the riders have valid tickets, tokens, cards, or codes. The fare gate 102 is equipped with fare media readers and barrier mechanisms, or the gate paddles. When the riders present a valid ticket, a token, a card, or a code at a fare media reader, the fare gate 102 opens the gate paddles and manages object flow. The fare gate 102 uses swinging paddles, retractable barriers, high entry/exit gates, pop-up barriers, or optical turnstiles as the barrier mechanisms. Fare evasion at the fare gate 102 impacts the transit system in several ways. Fare evaders cause revenue losses, damage the reputation of the transit system, pose security threats, and affect the quality and frequency of transit services. The fare gate 102 in the object detection system 100 is equipped with a radar 104 and a reflective surface 106.

The radar 104 is positioned at a first position of the fare gate 102. The first position can be a top gate cabinet, a left gate cabinet, or a right gate cabinet in the direction of the passenger's entry. The radar 104 emits a signal as a continuous-wave (CW) constant frequency electromagnetic (EM) wave or emits signals as short pulses of frequency-modulated continuous-wave (FMCW) signals. The radar 104 also emits pulse-doppler signals, combining pulse modulation with doppler effects. In an embodiment, the radar 104 is a light detection and ranging (LiDAR) system that emits a signal as light waves or a pulsed laser beam. In another embodiment, the radar 104 is a radio detection and ranging system that emits the signal as an EM wave in the direction of targets.

In an embodiment, the radar 104 is a mmWave radar, such as 60 GHz radar, positioned at the first position of the fare gate 102 for object and anomaly detection. The mmWave radar operates at high frequencies (30 GHz-300 GHz) and uses short wavelengths (1 mm-10 mm), allowing for high-resolution object detection. The mmWave radar emits the signals as short wavelengths in an EM spectrum. The mmWave radar detects details of riders or anomalies with their associated information, such as their sizes, shapes, placements, and movements. The mmWave radar emits high-frequency signals that penetrate through materials, like clothing, plastic, or glass. The short wavelengths of the mmWave radar allow for detailed object detection even in low visibility conditions. From hereinafter, the terms “radar” and “mmWave radar” are used interchangeably.

In an embodiment, the mmWave radar 104 emits frequency-modulated signals which reflect from the objects (passengers) present in a proximity of the fare gate 102. The mmWave radar 104 down-converts the high-frequency reflected signals to intermediate-frequency (IF) signals. The mmWave radar 104 processes the IF signals to extract information, such as range, velocity, shape, or angle of the object. The mmWave radar 104 analyzes frequency components of the reflected signals and estimates an angle of arrival (AoA). The mmWave radar 104 combines angle, velocity, shape, and/or range information to track the objects transiting through the fare gate 102.

The mmWave radar 104 generates a primary clustered point cloud from the signal reflected back from the object in a primary field-of-view (FOV). An FOV is an angular extent of the area that the radar 104 can locate and detect targets. The primary FOV is the angular extent to which the mmWave radar 104 detects the objects and the anomalies at the fare gate 102 without using FOV enhancement schemes. A point cloud is a collection of data points in 3-dimensional (3D) coordinates, representing a location of the object in space. The primary clustered point cloud represents the data points of the objects and the anomalies, detected at the fare gate 102 via the mmWave radar 104.

The mmWave radar 104 has object visibility within a line-of-sight (LoS) and the primary FOV. The LoS refers to a direct and unobstructed path between the mmWave radar 104 and the object, along which the signals travel to track the objects and the anomalies. A density and a distribution of the data points of the primary clustered point cloud provide information about size, shape, velocity, position, and material properties of the anomalies accompanied by the passengers. The high frequencies and the short wavelengths of the mmWave radar 104 provide object detection with high-resolution, less interference, and high penetration through materials. The reflective surface 106 enhances the primary FOV and the object visibility outside of the LoS of the mmWave radar 104.

The reflective surface 106 is positioned at a second position to enhance the primary FOV. The second position can be at the top gate cabinet, the left gate cabinet, or the right gate cabinet in the direction of the passenger's entry. The reflective surface 106 redirects the signals emitted by the mmWave radar 104 and gives a secondary FOV. The secondary FOV enhances the primary FOV of the mmWave radar 104 by increasing the LoS and creating a larger number of data points in its point cloud. The secondary FOV has a secondary clustered point cloud of the object transiting through the fare gate 102. The secondary clustered point cloud provides a higher density of data points as compared to the primary clustered point cloud. The reflective surface 106 adds reflections and refractions to the signals emitted by the radar 104 and provides the secondary FOV. In an embodiment, the number of the reflective surfaces 106 are increased to provide the secondary FOV that expands the primary FOV. Additional reflective surfaces expand the primary FOVs without any limit. The secondary FOV has the secondary clustered point cloud, which is saved in the transit store 108 for further processing via the ML engine 110.

The ML engine 110 is communicatively coupled with the transit store 108 and the forensic engine 112 through the network 114. The transit store 108 saves the primary clustered point cloud and the secondary clustered point cloud that are generated by the radar 104. The transit store 108 also saves point clouds along with their annotations, for example, class labels, edges, 3D bounding boxes, object geometry, or segmentations. From hereinafter, the primary clustered point cloud and the secondary clustered point cloud are collectively referred to as the point clouds. In an embodiment, the transit store 108 is a relational database using structured query language (SQL), such as MySQL, PostgreSQL, or an SQL server. In some other embodiments, the transit store 108 is a document store, a key-value store, a graph database, a time-series database, or a spatial database. In other embodiments, the transit store 108 is a cloud storage, a file-based storage, or a high-capacity local hard drive. To store the point clouds, the transit store 108 uses a LASer (LAS), LASzip (LAZ), or an entwine point tile (EPT) file format, organizing the point clouds into tiles or compressed versions. The transit store 108 is a repository for the point clouds and associated media, enabling the ML engine 110 to access the point clouds and annotate prediction outcomes.

The ML engine 110 processes the point clouds to detect the passengers and the anomalies in the object detection system 100. The ML engine 110 obtains the point clouds from the transit store 108. The ML engine 110 handles unstructured or sparse conditions of the point clouds, extracts different features of the objects and anomalies from the point clouds, and generates 3D bounding boxes. In an embodiment, the ML engine 110 extracts the features of the object from the primary clustered point cloud and the secondary clustered point cloud, which are organized in vertical columns or pillars. In another embodiment, the ML engine 110 converts the point clouds into voxel grids to extract and encode the features of the objects.

The ML engine 110 correlates the features with object profiles. An object profile is a clustered reference point cloud that represents patterns and structures of the objects transiting within the proximity of the fare gate 102. A subset of the object profiles includes anomalies. For example, the reference clustered point cloud of a passenger accompanied by a wheelchair indicates no anomaly. Alternatively, the reference clustered point cloud of the passenger accompanied by another passenger, while the fare media reader has detected a single ticket, is an anomaly and belongs to the subset. In an embodiment, the ML engine 110 performs temporal analysis on the clustered point clouds of the passengers to track the anomalies over time and leverages motion patterns and temporal consistency. The ML engine 110 correlates the features with the object profiles and graphs a feature evolution over time. Upon identifying the anomalies, the ML engine 110 generates the flag for the forensic engine 112.

The forensic engine 112 captures media corresponding to the object associated with the flag generated by the ML engine 110. The media captured by the forensic engine 112 includes images, video clips, or other formats that provide visual information about the object. The forensic engine 112 captures the media of the passengers and the anomalies at the fare gate 102. The forensic engine 112 is a combination of sensors, cameras, and a controller. The sensors of the forensic engine 112 detect the flag and trigger the controller that activates the cameras to capture the media. The media is temporarily stored in the controller's storage and sent to the transit store 108 for backup and further processing. The forensic engine 112 operates at time intervals and/or at sensitivity levels during the peak volumes of the transit system. The flag generated by the ML engine 110, along with the media of the object associated with the flag, is sent to the node 116 over the network 114.

The network 114 communicatively couples the fare gate 102 with the node 116, the forensic engine 112, the ML engine 110, and the transit store 108. The network 114 facilitates the transfer of the point clouds, flags, media associated with the flags, and other data within the object detection system 100. In an embodiment, the network 114 is a wired network such as a local area network (LAN), an ethernet cable, or a fiber-optic cable. In another embodiment, the network 114 is a wireless network that uses radio waves or infrared signals for communications. The network 114 sends the media to the node 116 and allows the ML engine 110 to access the point clouds from the transit store 108. The node 116 displays the media on a screen attached to the node 116 or provides system notifications based on the flag and the media. The node 116 executes instructions from software applications and features components, like processors, node sensors, user interfaces, and hardware resources. The node 116 is a computer, a laptop, a mobile phone, a tablet, a console, or an internet-of-things (IOT) device with authorized identity and access in the object detection system 100.

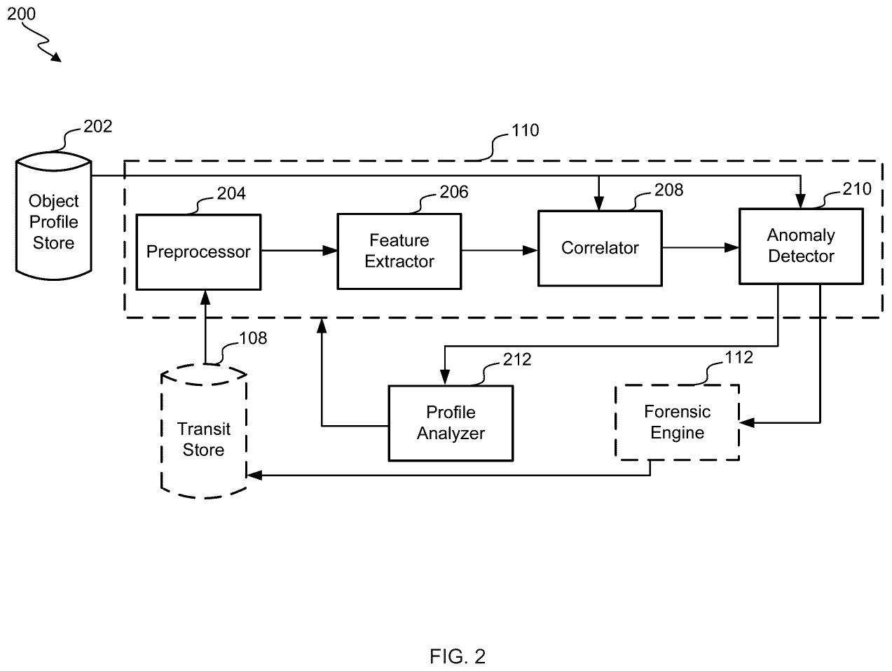

Referring next to FIG. 2, a detection workflow 200 via the ML engine 110 is shown as an embodiment. The detection workflow 200 processes the point clouds, assesses the object profile, and updates engine parameters upon encountering an error in the object detection. The detection workflow 200 includes an object profile store 202, the ML engine 110, the forensic engine 112, the profile analyzer 212, and the transit store 108. The ML engine 110 further includes a preprocessor 204, a feature extractor 206, a correlator 208, and an anomaly detector 210.

In an embodiment, the object profile store 202 is an internal database of an entity to store and manage the object profiles along with associated media of the objects and the anomalies. The entity includes a company or a business unit that integrates the fare gate 102 into transit systems. The object profile store 202 keeps the object profiles with detailed spatial as well as temporal features of the passengers and the anomalies. Examples of the object profiles include and are not limited to the object profiles representing a passenger, the passenger accompanied by a child in a stroller, or the passenger with a backpack. The subset of the object profiles includes anomalies and adheres to the policies of the entity. For example, the object profiles showing the passenger engaged in tailoring activities within an aisle, or the object profiles of two passengers transiting through the fare gate 102 without scanning the token. The subset contains the object profiles with unusual and suspicious patterns that deviate from normal point clouds or the policies of the entity. The subset further includes the object profiles indicating suspicious passenger movements, unidentified objects, or the impermissible materials.

The object profile store 202 saves the clustered reference point cloud and its associated media. The object profile store 202 saves the object profiles, metadata tags, and anomaly indicators. The metadata tags indicate the types of objects transiting through the fare gate 102, e.g., a valid passenger or a passenger with wrong entry patterns. The object profile store 202 has restricted access and encrypts the policies of the entity and the object profiles for security and privacy reasons. In some embodiments, the object profile store 202 is a relational database, an object-oriented database, a time series database, a vector database, or a cloud database. The object profile store 202 provides the object profiles to the ML engine 110 for the object and the anomaly detection at the fare gate 102.

The preprocessor 204 of the ML engine 110 transforms the primary clustered point cloud and the secondary clustered point cloud into usable formats. The preprocessor 204 cleans the point clouds by removing noise and filling in missing data points. The preprocessor 204 adjusts the scales of the point clouds to a common range. The preprocessor 204 applies data transformation techniques, such as log transformation or polynomial expansion, to increase the details of the data points of the point clouds. The preprocessor 204 eliminates data inconsistencies in the point clouds, laying a base for feature extraction and analysis.

The feature extractor 206 of the ML engine 110 extracts features of the object from the primary clustered point cloud and the secondary clustered point cloud. The feature extractor 206 uses clean and normalized point clouds to extract the features of the passengers transiting through the object detection system 100. In an embodiment, the feature extractor 206 applies signal processing to the point clouds of EM waves and extracts frequency components from time-series or spatial point clouds. In another embodiment, the feature extractor 206 applies computer vision or statistical methods to identify patterns and the features within the point clouds. The ML engine 110 uses the features to find a correlation between the clustered point clouds and the object profiles from the object profile store 202.

The correlator 208 of the ML engine 110 correlates the features with the object profiles, where the subset of the object profiles includes the anomalies. The correlator 208 determines the statistical associations between the primary clustered point cloud, the secondary clustered point cloud, and the object profiles. The correlator 208 accesses the object profiles from the object profile store 202 and quantifies a degree of similarity or association between the point clouds and the object profiles. The correlator 208 performs a time-series correlation to track variations of the features over time. The correlator 208 identifies the top relevant features through correlation analysis for the object and the anomaly detection at the fare gate 102.

The anomaly detector 210 categorizes the passengers based on correlation analysis of the point clouds and the policies of the entity stored in the object profile store 202. The anomaly detector 210 uses temporal and spatial features of the objects to detect the passengers and the anomalies. The anomaly detector 210 maintains the stability of knowledge about detected objects and prevents forgetting previously acquired object profiles. When the anomaly detector 210 identifies that the passengers or the patterns of the passengers belong to the object profiles of the subset, the anomaly detector 210 generates a flag for the forensic engine 112. For the detected objects and the anomalies, the anomaly detector 210 signals the profile analyzer 212 for object profile assessment.

The profile analyzer 212 assesses the object profiles determined by the ML engine 110 and analyzes errors. The errors include misclassification or false flag generation. The profile analyzer 212 compares the detection outcomes against ground truth labels and calculates metrics, such as precision, recall, and F1-score, to detect discrepancies. The profile analyzer 212 investigates the errors and tunes the engine parameters, such as learning rate, feature weights, or other hyperparameters. The profile analyzer 212 updates the engine parameters based on feedback. The feedback includes trigger signals or information on true detection, false detection, or uncertain point clouds. The profile analyzer 212 facilitates continuous learning and refinement of the ML engine 110 using the feedback. The profile analyzer 212 also facilitates retraining of the ML engine 110.

In an embodiment, the ML engine 110 is trained by sampling the clustered point clouds and updating the engine parameters based on the feedback and error analysis. The ML engine 110 is trained by sampling the primary point clouds and the secondary point clouds, where a training subset of the data points is selected from the point clouds. The training further includes adjusting and updating the engine parameters to minimize loss functions. The ML engine 110 is evaluated using validation data points and calculating metrics, such as precision, recall, and F1-score. The object profiles determined by the ML engine 110 are assessed and errors are analyzed. The engine parameters are updated via reinforcement learning or active learning based on the feedback regarding true or false detection.

In an embodiment, the ML engine 110 is initially trained with the primary clustered point cloud only. Then, the reflective surface 106 is introduced, and the ML engine 110 is trained to determine which reflections are coming from the primary FOV and which ones are coming from the secondary FOV with the reflective surface 106. The secondary FOV is an expansion in the primary FOV. The ML engine 110 processes the primary point cloud and the secondary point cloud by using density-based spatial clustering of applications with noise (DBSCAN) algorithms to separate multiple objects in the clustered reference point cloud. In another embodiment, the ML engine 110 clusters the primary point cloud by using the DBSCAN algorithm or other similar clustering techniques. The ML engine 110 distinguishes between various objects from the clustered reference point cloud and examines their composition. This information is fed into a reinforced learning algorithm to classify the object into frequently encountered categories in the transit systems such as smartphones, pets, or backpacks. The reinforced learning algorithm detects prohibited objects such as concealed weapons.

In another embodiment, the ML engine 110 is trained via adversarial training. The ML engine 110 is continuously monitored after deployment, tracking evaluation metrics, analyzing errors, and updating the engine parameters accordingly. The profile analyzer 212 collects feedback from the deployed ML engine and retrains the ML engine 110 with field learning. The profile analyzer 212 regularly updates the engine parameters of the ML engine 110 to adapt to new primary clustered point cloud, new secondary clustered point cloud, and changing conditions.

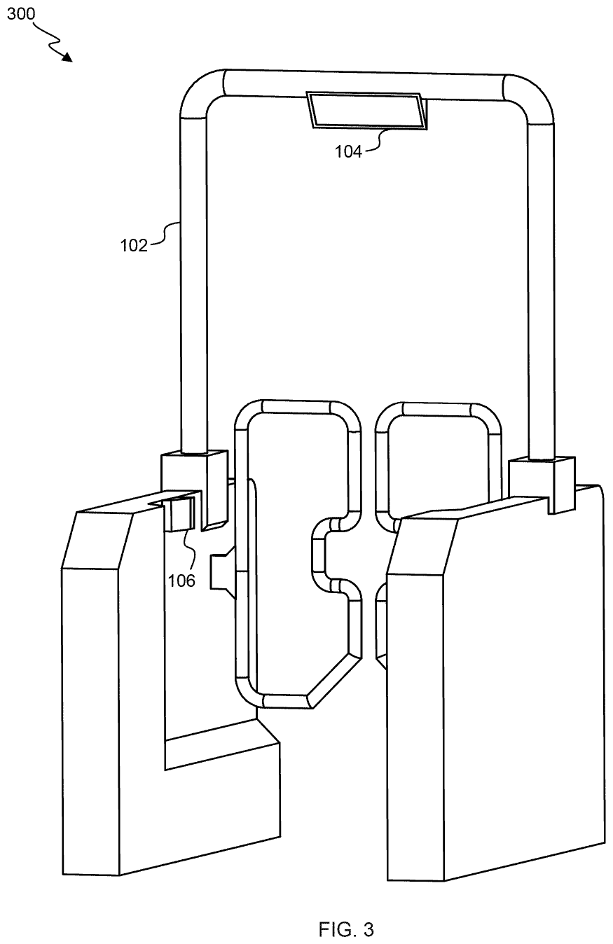

Referring next to FIG. 3, a perspective view 300 of the fare gate 102 with the radar 104 and the reflective surface 106 positioned at the fare gate 102, is shown as an embodiment. The radar 104 is positioned at the first position, i.e., the top gate cabinet. The radar 104 tracks, locates, and identifies different passengers and the anomalies. The radar 104 emits the signals at incidence angles, including horizontal and vertical incidence angles. The incidence angles describe the orientation of the polarization of the signal, relative to the object and reflective surfaces 106. The mmWave radar 104 generates the primary clustered point cloud in the primary FOV.

The reflective surface 106 is positioned at the second position, i.e., the left gate cabinet. The reflective surface 106 redirects the signals at reflection angles. The incidence angles and the reflection angles affect an electromagnetic response of the reflective surface 106. The reflective surface 106 has the secondary FOV with the secondary clustered point cloud and manipulates the EM waves with their sub-wavelength features. In another embodiment, the reflective surface 106 is a reconfigurable metasurface, consisting of meta-elements with a variable geometric shape. The reconfigurable metasurface includes sub-wavelength of less than λ/2 sized spatially arranged unit-cell patches with a variable geometry in a phase pattern required to create an anomalous reflection in a direction of interest. The shape of unit-cell patches is chosen to ensure their polarization insensitivity in reflecting transverse electric (TE) and transverse magnetic (TM) propagation modes. From hereinafter, the terms “reflective surface” and “metasurface” are used interchangeably. In another embodiment, the reflective surface is electrically reconfigurable through the incursion of phase switching elements such as PIN diodes, varactor diodes, RF-switches, or liquid crystal layers. These elements are placed symmetrically on unit-cell patches to ensure polarization insensitivity with two elements required per each unit-cell patch, one for TE propagation mode and one for TM propagation mode. The control of these elements is performed with an independent processor, from hereinafter referred to as the “reflective surface controller”. In that case, the geometric shape variations are not required, and all unit-cells patches of the reflective surface are of the same size.

The metasurface 106 consists of meta-atoms to impart the signals emitted by the mmWave radar 104. The metasurface 106 modulates the amplitude, polarization, and phase of the EM wave for wavefront shaping and beam forming. The variable geometric shape and composition of the meta-atoms or electrical configuration of phase shifting elements via the reflective surface controller help achieve an abnormal but desired permittivity and permeability from the metasurface 106. The metasurface 106 is positioned at the second position of the fare gate 102 to achieve signal reflections or signal refractions that are anomalous to Snell's law. Snell's law defines how light, or the EM waves change their direction while passing through a medium. The metasurface 106 manipulates the signals emitted from the mmWave radar 104 to introduce phase shifts that deviate from the Snell's law. The metasurface 106 steers the radar beam to angles outside the LoS and the primary FOV.

The metasurface 106 reduces the scatter and clutter of the signals and enables a non-line-of-sight (NLoS) detection by reflecting the signals around obstacles in the object detection system 100. In an embodiment, the metasurface 106 is a flexible reflective metasurface or an optically transparent transmissive metasurface. The meta-atoms are fabricated to form a pattern of the metasurface 106. The pattern of the metasurface 106 delivers a polarization insensitive response to the signals emitted by the mmWave radar 104. The pattern of the metasurface 106 manipulates the signals regardless of their polarization states. The polarization insensitive response is achieved through symmetric structures of the meta-atoms, material properties, and/or consistent phase gradients to impart phase shifts to the EM waves. The metasurface 106 reflects the signals at the reflection angles, including horizontal and vertical reflection angles. The reflection angles affect the density of the primary clustered point cloud and generate detailed data points. The detailed data points are the secondary clustered point cloud of the object in the secondary FOV.

In an embodiment, the mmWave radar 104 is positioned at the top gate cabinet, and the metasurface 106 is positioned at the left gate cabinet. In another embodiment, the metasurface 106 is positioned at the right gate cabinet. In yet another embodiment, two metasurfaces are used. One metasurface is positioned at the left gate cabinet, and a second metasurface is positioned at the right gate cabinet of the fare gate 102.

In an embodiment, the primary FOV of the mmWave radar 104 is enhanced by connecting multiple mmWave radars in parallel and using the reflective surfaces 106. In another embodiment, the primary FOV of the mmWave radar 104 is enhanced by using a sensor fusion system. The sensor fusion system integrates different types of sensors, such as the mmWave radar(s) 104, LiDAR, and cameras. In some embodiments, the primary FOV of the mmWave radar 104 is enhanced and the secondary FOV is generated by employing a large active phased array of the mmWave radar(s) 104 along with the metasurfaces 106.

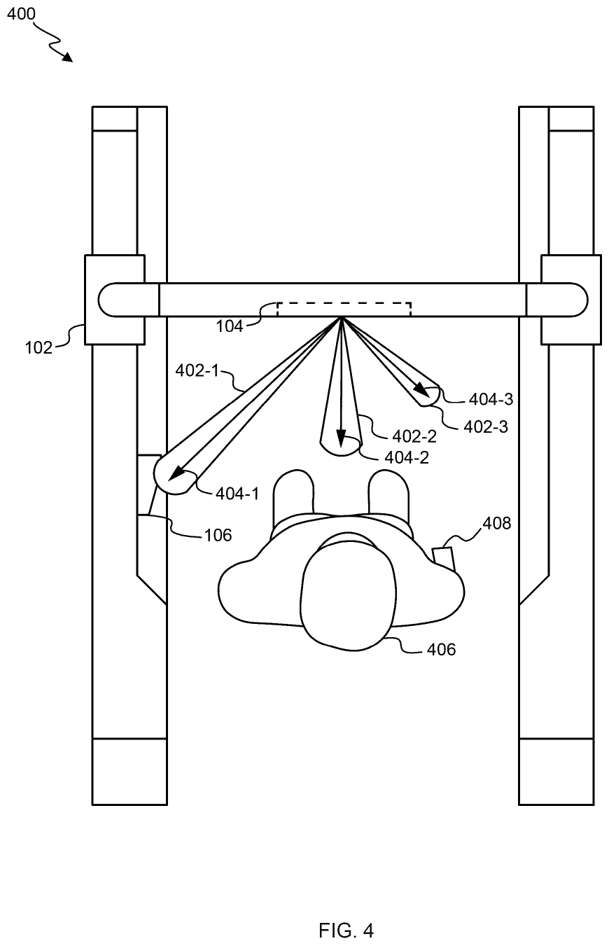

Referring next to FIG. 4, a top view 400 of the fare gate 102 with an object 406 transiting through the fare gate 102, is shown as an embodiment. The top view 400 includes signals 402 (402-1, 402-2, 402-3) emitted by the mmWave radar 104. The top view 400 further includes signal directions 404 (404-1, 404-2, 404-3), an object 406 accompanied by an anomaly 408, and the metasurface 106 at the left gate cabinet. Examples of the anomaly 408 include, but are not limited to, suspicious passenger movements, unidentified passenger patterns, or impermissible objects. The mmWave radar 104 emits the signals 402 to detect the object 406 in the primary FOV. The signals 402 include multiple EM waves, where some of the EM waves partially overlap.

In an embodiment, the mmWave radar 104 is positioned at the top gate cabinet. A first signal 402-1 with a first signal direction 404-1 incidents on the metasurface 106. The metasurface 106 reflects the first signal 402-1 at the reflection angles. A second signal 402-2 with a second signal direction 404-2 and a third signal 402-3 with a third signal direction 404-3 reflect off the object 406 and the anomaly 408. The second signal 402-2 and the third signal 402-3 arrive at the mmWave radar 104, generating the primary clustered point cloud. The first signal 402-1, reflected off the object 406 through the metasurface 106, arrives at the mmWave radar 104 and generates the secondary clustered point cloud. The point clouds contain spatial properties of the object 406, for example, a position of the object 406, surface texture, a shape of the anomaly 408, and/or velocity of the object 406 if it is moving. The ML engine 110 collects the point clouds, correlates the spatial features with the object profiles, and determines if the object 406 is accompanied by the anomaly 408.

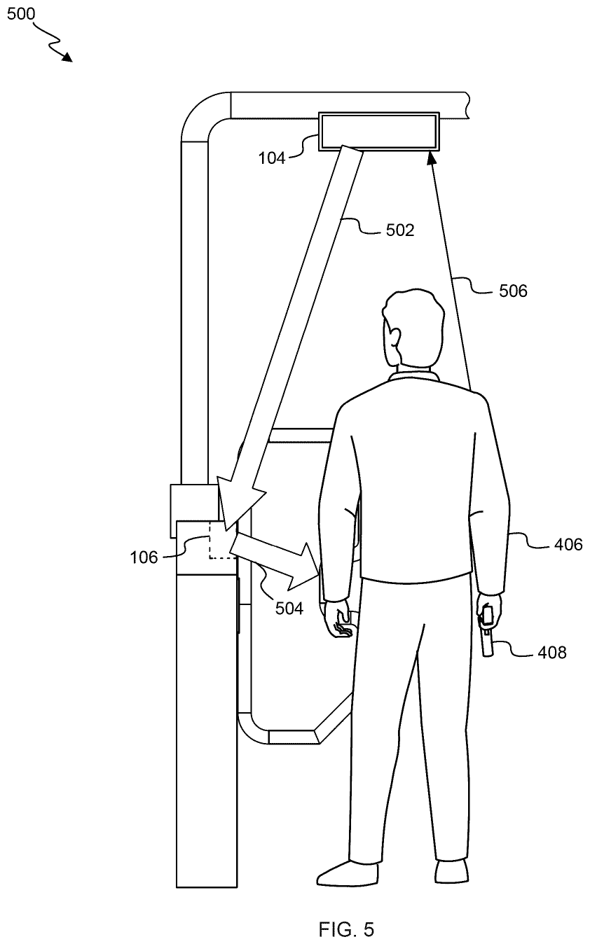

Referring next to FIG. 5, a front sectional view 500 of the fare gate 102 with incidence angles 502 and reflection angles 504 of the signals 402, is shown as an embodiment. The incidence angles 502 include the horizontal incidence angle as θinc, and the vertical incidence angle as φinc. The reflection angles 504 include the horizontal reflection angle as θR, and the vertical reflection angle as φR. The incidence angles 502 and the reflection angles 504 help detect a vertical structure and a horizontal structure of the object 406 and of the anomaly 408.

In an embodiment, the pattern of the metasurface 106 is engineered based on the incidence angles 502 and the reflection angles 504. For example, the 60 GHz radar is positioned at the fare gate 102 as the mmWave radar 104. Based on the position of the 60 GHz radar at the top gate cabinet, the signals 402 incident on the metasurface 106 at θinc=26° and φinc=6°. The metasurface 106 is then engineered to provide the polarization insensitive response with θR=64° and φR=45°. The reflection angles 504 affect the polarization of the signals 402 emitted by the 60 GHz radar.

In an embodiment, the mmWave radar 104 emits the signals 402 that directly reflect off the object 406 and return to the mmWave radar 104 at angle of arrivals (AoA) 506. The AoA 506 are directions from which the signals 402 return to the mmWave radar 104. A Kalman filter is implemented within the ML engine 110 to estimate vertical and horizontal AoAs, a distance from the mmWave radar 104, and a velocity of moving object. The mmWave radar 104 generates the primary clustered point cloud to detect the position, shape, and movement of the object 406 transiting through the fare gate 102 with the anomaly 408. The data points in the primary clustered point cloud are sparse and the primary FOV is limited to the LoS of the mmWave radar 104. In another embodiment, the signals 402 incident on the pattern of the metasurface 106 at θinc=26° and φinc=6°. The signals 402 reflect off the metasurface 106 at θR=64° and φR=45°, hit the object 406, and return to the mmWave radar 104 at the AoA 506. The mmWave radar 104 generates the secondary clustered point cloud. The reflections from the metasurface 106 enhance the intensity of the data points in the secondary clustered point cloud and generate the secondary FOV. The secondary FOV redirects the signals 402 to the NLoS of the mmWave radar 104.

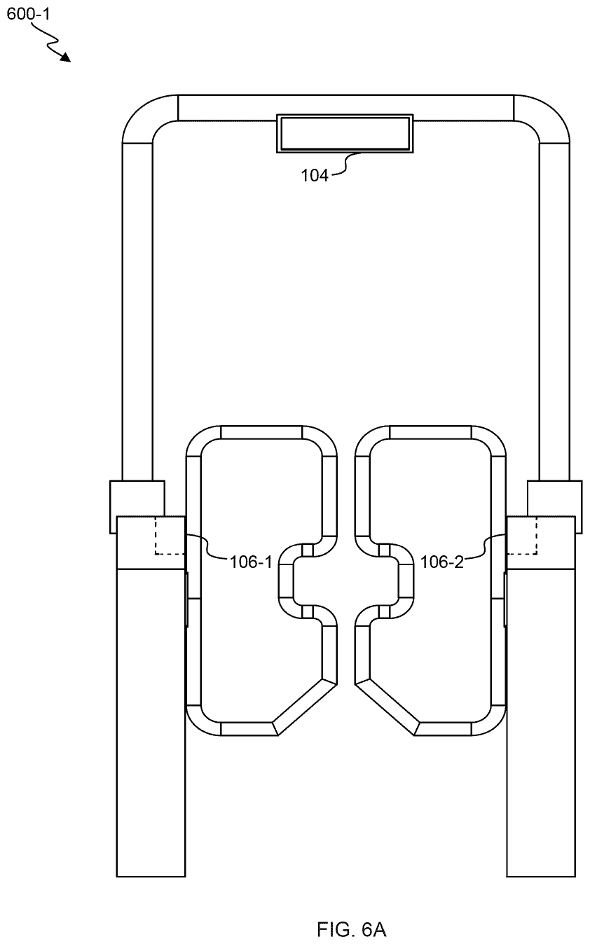

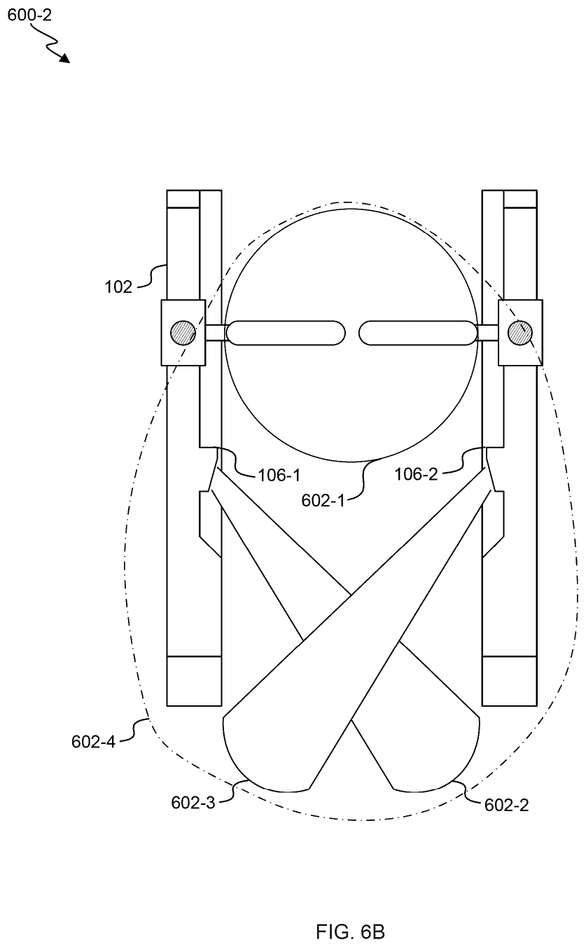

Referring next to FIG. 6A, a front view 600-1 of the fare gate 102 with a first reflective surface 106-1 and a second reflective surface 106-2 positioned at the fare gate 102, is shown as an embodiment. The front view 600-1 shows positioning of different metasurfaces at the fare gate 102 to enhance a detection range and the primary FOV of the mmWave radar 104 in the object detection system 100. The first metasurface 106-1 and the second metasurface 106-2 enhance the primary FOV by providing the secondary clustered point cloud in the secondary FOV. The secondary FOV enhances the ability of the mmWave radar 104 to detect the objects in the NLoS. The primary FOV and the secondary FOV are variable based on a position of the radar 104 and a position of the reflective surface 106 as spherical coordinates.

In some embodiments, if the first reflective surface 106-1 gets blocked due to environmental factors or any suspicious conditions, the second reflective surface 106-2 provides FOV enhancement for the mmWave radar 104. The ML engine 110 detects unavailability of the first metasurface 106-1 based on baseline models, processes the point clouds, and signals the node 116 about the first metasurface 106-1 blockage. In some other embodiments, if both of the metasurfaces get blocked, the radar 104 still detects the objects 406 and the anomaly 408 in its LoS. The ML engine 110 detects the unavailability of the metasurfaces 106 based on the sparsity of the point clouds and uses the baseline models. The ML engine 110 signals the node 116 about the blockage or unavailability of the metasurfaces 106.

Referring next to FIG. 6B, a top sectional view 600-2 of the fare gate 102 with field-of-views (FOVs) 602 (602-1, 602-2, 602-3 and 602-4) is shown as an embodiment. The top sectional view 600-2 of the fare gate 102 shows the FOVs 602 when the first metasurface 106-1 and the second metasurface 106-2 are positioned at the fare gate 102 along with the mmWave radar 104. A primary FOV 602-1 is the FOV in the LoS of the radar 104. In an embodiment, the primary FOV 602-1 is a conical FOV with a circular base and is centered around 0°. The primary FOV 602-1 covers a symmetrical angular view and provides the primary clustered point cloud. The primary FOV 602-1 is enhanced by anomalous reflections of the signals 402 through two metasurfaces. The first metasurface 106-1 is positioned at the left gate cabinet, and the second metasurface 106-2 is positioned at the right gate cabinet. The two metasurfaces provide beam steering in secondary FOVs (602-2, 602-3). The first metasurface 106-1 at the left gate cabinet anomalously reflects the signals 402 and has a left secondary FOV 602-2. The second metasurface 106-2 at the right gate cabinet also reflects the signals 402 anomalously and has a right secondary FOV 602-3.

The anomalous reflections in the secondary FOVs (602-2, 602-3) provide beam steering by imposing a phase gradient along the x-axis. The secondary FOVs (602-2, 602-3) form tilted conical shapes with directions relative to the LoS of the mmWave radar 104, allowing the object detection in the NLoS of the mmWave radar 104. In an embodiment, FOV enhancement is achieved by combining the phase ranges covered by the primary FOV 602-1 and the secondary FOVs (602-2, 602-3). An enhanced FOV 602-4 is a total phase range covered by the mmWave radars 104 when positioned on the fare gate 102 along with the metasurfaces 106. The enhanced FOV 602-4 provides object detection capabilities to the mmWave radar 104 in a wider detection range without physically rotating the mmWave radar 104.

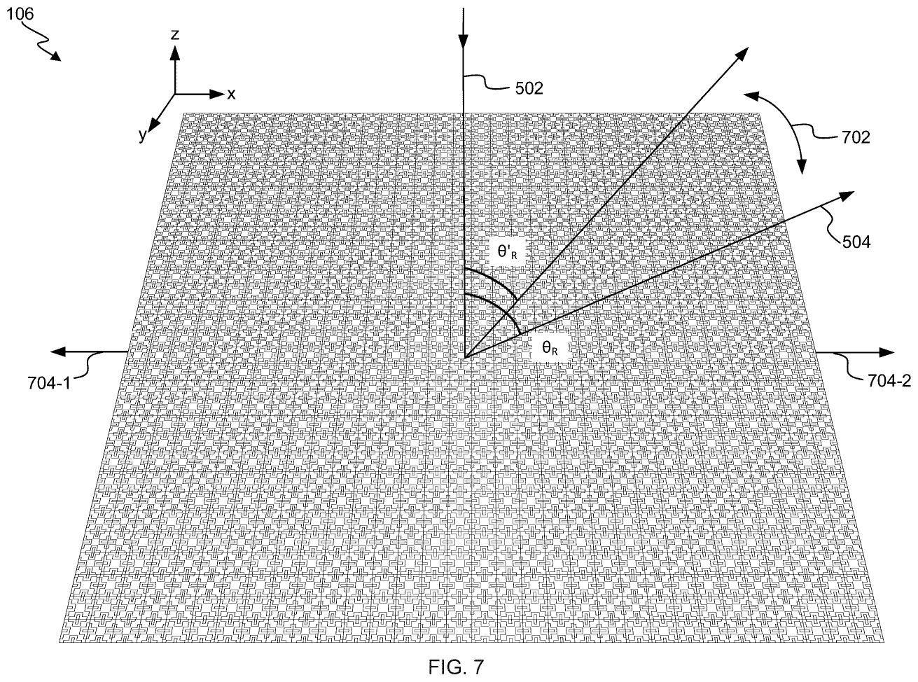

Referring next to FIG. 7, the reflective surface 106 engineered for the beam steering at the reflection angles 504, is shown as an embodiment. The reflective surface 106 is shown with signal incidences and signal reflections in a 3D coordinate (along x, y, and z) system. The reflective surface 106 is patterned to obtain a 300°+phase range. In an embodiment, the metasurface 106 is passive and contains copper layers and a substrate in between the copper layers. The copper layers of the metasurface 106 are stacked as a top copper layer and a bottom copper layer with the substrate in between the top and the bottom copper layers. The copper layers are composed of copper meta-atoms to interact with EM fields generated by the signals 402. The substrate influences EM properties of the metasurface 106. The substrate between the copper layers of the metasurface 106 is a dielectric, a flexible substrate, or a flame retardant 4 (FR4). In another embodiment, Rogers RO4003 is used as the substrate between the copper layers of the metasurface 106. The Rogers RO4003 has a controlled dielectric constant and provides stability for high frequency ranges of the mmWave radar 104, such as 60 GHz. The reflective surface 106 further includes the wavelength-related spatially arranged unit-cell patches with the variable geometry in the phase pattern that is required to create the anomalous reflection in the direction of interest.

In an embodiment, the size of the reflective surface 106 is a function of an operational frequency wavelength (λ) of the radar 104 and an aperture efficiency. For the 60 GHz radar, the operational frequency wavelength (λ) is 5 mm. In another embodiment, the size of the reflective surface 106 for the 60 GHz radar has to be no less than 15×λ to have an adequate aperture efficiency of the surface for the selected distance to the radar and its nominal transmit power, which is equal to 12 dBm plus˜8 dBi antenna patch gain. The unit-cell patch size is chosen as λ/4. Therefore, the metasurface 106 with the size 96×96 mm is chosen, which exceeds requirement for this embodiment. This compact size enables the metasurface 106 to be positioned at the second position of the fare gate 102 without changing a mechanical design of the fare gate 102. The metasurface 106 with copper layers and with the size 96×96 mm provides an economical solution for the object 406 and the anomaly 408 detection at the fare gate 102.

In an embodiment, the metasurface 106 is engineered for the reflection angles 504 (θR=64° and φR=45). The spherical coordinates for the position of the mmWave radar 104 and the spherical coordinates for the position of the metasurface 106 influence the incidence angles 502 and the reflection angles 504. The signals 402 incident on the metasurface 106 at the incidence angles 502. The metasurface 106 provides anomalous reflections at the reflection angles 504. A beam steering 702 controls the direction of reflected signals without physically moving the mmWave radar 104 or the metasurface 106. The beam steering 702 introduces a spatial phase gradient, redirecting the signals 402 at reflection angles θR.

In an embodiment, the metasurface 106 is the flexible reflective metasurface and can be stretched sideways. A stretch at a first sideway 704-1 or at a second sideway 704-2 changes the phase gradients of the metasurface 106. The stretching modifies the spacing of the meta-elements and alters the optical path differences. A controlled stretching of the metasurface 106 steers the signals 402 from the reflection angles θR to stretched angles θ′R.

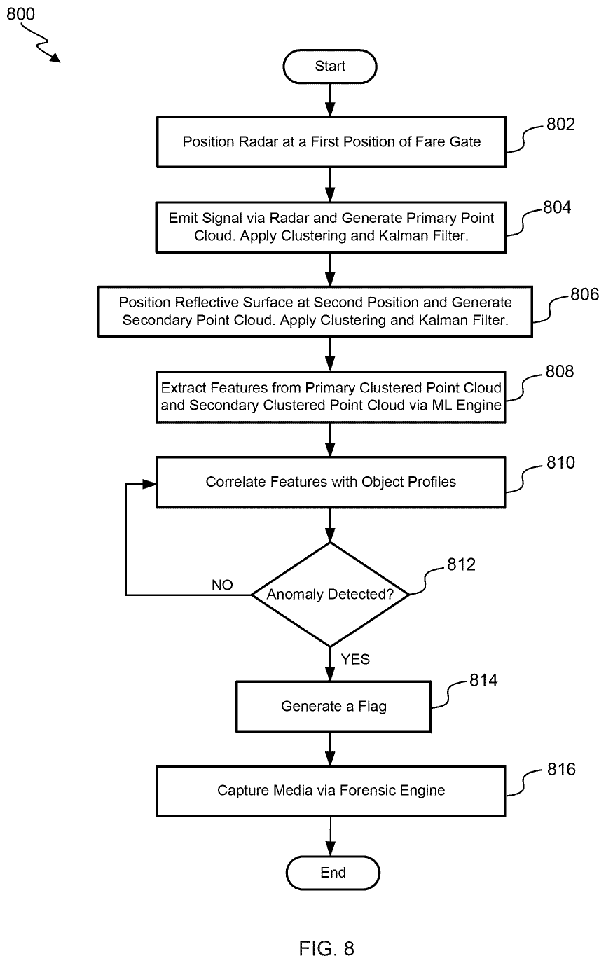

Referring next to FIG. 8, a detection method 800 for object detection at the fare gate 102, is shown as an embodiment. The detection method 800 tracks fare evasion of the object 406 and the presence of the anomaly 408 associated with the object 406 at the fare gate 102. The object 406 refers to the rider or the passenger transiting through the fare gate 102 either alone or accompanied by other objects, such as other passengers, luggage, strollers, dogs, or weapons. The detection method 800 tracks the wrong entry or tailgating, where the rider attempts to pass through the fare gate 102 closely behind another rider to gain unauthorized access. The detection method 800 also detects the riders crawling under or jumping over the fare gate 102, forcing gate paddles, or loitering in the aisle. The detection method 800 detects the riders transiting through the fare gate 102 with any associated anomaly.

At block 802, the radar 104 is positioned at the first position of the fare gate 102. The first position can be the top gate cabinet, the left gate cabinet, or the right gate cabinet, in the direction of the passenger's entry. In an embodiment, the radar 104 is positioned at the top gate cabinet to track, locate, and identify different passengers and anomalies in the object detection system 100. At block 804, the radar emits the signals 402 and generates the primary clustered point cloud from the signal reflected from the object 406 in the primary FOV 602-1. A prediction-based Kalman filter is applied to the primary clustered point cloud to estimate the trajectory and speed of moving objects. The radar 104 emits the signals 402 as the FMCW signals at the incidence angles 502. The radar 104 has the object visibility within the detection range, LoS, and the primary FOV 602-1. The primary clustered point cloud is data points in the primary FOV 602-1, representing the 3D coordinates of the passengers and the anomalies that are detected at the fare gate 102.

At block 806, the reflective surface 106 is positioned at the second position of the fare gate 102. The reflective surface 106 redirects the signals 402 emitted by the radar 104 and gives the secondary FOVs (602-2, 602-3). The secondary FOVs (602-2, 602-3) have the secondary clustered point cloud of the object 406 transiting through the fare gate 102. A prediction-based Kalman filter is also applied to the secondary clustered point cloud to estimate the trajectory and speed of moving objects. The reflective surface 106 adds reflections or refractions to the signals 402 and manipulates the EM waves with their sub-wavelength features.

At block 808, the ML engine 110 extracts different features from the primary point cloud and the secondary point cloud. The ML engine 110 learns and extracts features of the passengers and the anomalies from the point clouds. The Kalman filter is implemented within the ML engine 110 to estimate the vertical and horizontal AoAs, the distance from the mmWave radar 104, and the velocity of the moving object. At block 810, the ML engine 110 correlates the features with the object profiles. The correlator 208 determines the statistical associations between the primary clustered point cloud, the secondary clustered point cloud, and the object profiles.

At block 812, the object detection system 100 checks if the anomaly 408 is detected. The anomaly 408 belongs to the subset of the object profiles. The anomaly detector 210 categorizes the passengers based on the correlation analysis of the point clouds and the policies of the entity stored in the object profile store 202. If the anomaly 408 is not detected, the object detection system 100 continues correlating the object profiles with the features at block 810. If the anomaly 408 is detected, the object detection system 100 generates the flag at block 814. The anomaly detector 210 identifies the objects or the patterns of the object 406 belonging to the object profiles of the subset. The anomaly detector 210 generates the flag for the forensic engine 112. At block 816, the forensic engine 112 captures media corresponding to the object 406 associated with the flag.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. An object detection system to detect an object transiting through a fare gate in a transit system, the object detection system comprises:
a radar positioned at a first position of the fare gate, wherein the radar:
emits a signal, and
generates a primary point cloud from the signal reflected back from the object in a primary field-of-view (FOV);
clustering the primary point cloud to produce a primary clustered point cloud;
a reflective surface positioned at a second position of the fare gate, wherein:
the reflective surface has a secondary FOV, and
the secondary FOV has a secondary clustered point cloud of the object;
a machine learning (ML) engine, wherein the ML engine is operable to:
extract a plurality of features of the object from the primary clustered point cloud and the secondary clustered point cloud,
correlate the plurality of features with a plurality of object profiles, wherein a subset of the plurality of object profiles includes anomalies,
determine an object profile corresponding with an anomaly associated with the object, and
generate a flag upon identifying the anomaly; and
a forensic engine to capture media corresponding to the object associated with the flag.

2. The object detection system to detect the object transiting through the fare gate in the transit system of claim 1, wherein the primary FOV and the secondary FOV are variable based on a position of the radar and a position of the reflective surface as a plurality of spherical coordinates.

3. The object detection system to detect the object transiting through the fare gate in the transit system of claim 1, wherein the reflective surface is passive and comprises:
a plurality of copper layers and a substrate in between the plurality of copper layers; and
a plurality of wavelength-related spatially arranged unit-cell patches with a variable geometry in a phase pattern.

4. The object detection system to detect the object transiting through the fare gate in the transit system of claim 1, wherein the reflective surface comprises a pattern that delivers a polarization insensitive response.

5. The object detection system to detect the object transiting through the fare gate in the transit system of claim 1, wherein the reflective surface has a size that is a function of an operational frequency wavelength and transmit power of the radar and an aperture efficiency of the reflective surface that depends on the distance to the radar.

6. The object detection system to detect the object transiting through the fare gate in the transit system of claim 1, wherein:
the radar emits the signal at a plurality of incidence angles,
the reflective surface reflects the signal at a plurality of reflection angles, and
the plurality of incidence angles and the plurality of reflection angles affect an electromagnetic response of the reflective surface.

7. The object detection system to detect the object transiting through the fare gate in the transit system of claim 1, further comprises a plurality of reflective surfaces and a plurality of radars.

8. The object detection system to detect the object transiting through the fare gate in the transit system of claim 1, wherein the ML engine is trained by:
sampling a plurality of primary clustered point clouds and a plurality of secondary clustered point clouds,
assessing the plurality of object profiles determined by the ML engine, and
analyzing errors and updating engine parameters based on feedback.

9. An object detection method for detecting an object transiting through a fare gate in a transit system, the object detection method comprises:
positioning a radar at a first position of the fare gate, wherein the radar:
emits a signal, and
generates a primary clustered point cloud from the signal reflected back from the object in a primary field-of-view (FOV);
positioning a reflective surface at a second position of the fare gate, wherein:
the reflective surface has a secondary FOV, and the secondary FOV has a secondary clustered point cloud of the object;
configuring a machine learning (ML) engine to:
extract a plurality of features of the object from the primary clustered point cloud and the secondary clustered point cloud,
correlate the plurality of features with a plurality of object profiles, wherein a subset of the plurality of object profiles includes anomalies,
determine an object profile corresponding with an anomaly associated with the object, and
generate a flag upon identifying the anomaly; and
capturing media corresponding to the object associated with the flag via a forensic engine.

10. The object detection method for detecting the object transiting through the fare gate in the transit system of claim 9, wherein the primary FOV and the secondary FOV are variable based on a position of the radar and a position of the reflective surface as a plurality of spherical coordinates.

11. The object detection method for detecting the object transiting through the fare gate in the transit system of claim 9, wherein configuring the ML engine comprises training the ML engine by:
sampling a plurality of primary point clouds and a plurality of secondary point clouds,
assessing the plurality of object profiles determined by the ML engine, and
analyzing errors and updating engine parameters based on feedback.

12. The object detection method for detecting the object transiting through the fare gate in the transit system of claim 9, wherein:
the radar emits the signal at a plurality of incidence angles,
the reflective surface reflects the signal at a plurality of reflection angles, and
the plurality of incidence angles and the plurality of reflection angles affect an electromagnetic response of the reflective surface.

13. The object detection method for detecting the object transiting through the fare gate in the transit system of claim 9, wherein the reflective surface is passive and comprises:
a plurality of copper layers and a substrate in between the plurality of copper layers; and
a plurality of wavelength-related spatially arranged unit-cell patches with a variable geometry in a phase pattern.

14. The object detection method for detecting the object transiting through the fare gate in the transit system of claim 9, wherein the reflective surface comprises a pattern that delivers a polarization insensitive response.

15. The object detection method for detecting the object transiting through the fare gate in the transit system of claim 9, wherein the reflective surface has a size that is a function of an operational frequency wavelength of the radar and an aperture efficiency.

16. A machine-readable medium having machine-executable instructions embodied thereon that, when executed by one or more processors, facilitate a method for object detection for detecting an object transiting through a fare gate in a transit system, wherein the method comprises:
positioning a radar at a first position of the fare gate, wherein the radar:
emits a signal, and
generates a primary point cloud from the signal reflected back from the object in a primary field-of-view (FOV);
positioning a reflective surface at a second position of the fare gate, wherein:
the reflective surface has a secondary FOV, and the secondary FOV has a secondary point cloud of the object;
configuring a machine learning (ML) engine to:
extract a plurality of features of the object from the primary point cloud and the secondary point cloud,
correlate the plurality of features with a plurality of object profiles, wherein a subset of the plurality of object profiles includes anomalies,
determine an object profile corresponding with an anomaly associated with the object, and
generate a flag upon identifying the anomaly; and
capturing media corresponding to the object associated with the flag via a forensic engine.

17. The machine-readable medium, facilitating the method for object detection for detecting the object transiting through the fare gate in the transit system, of claim 16, wherein the primary point cloud and/the secondary point cloud are processed with a clustering algorithm.

18. The machine-readable medium, facilitating the method for object detection for detecting the object transiting through the fare gate in the transit system, of claim 16, wherein configuring the ML engine comprises training the ML engine by:
sampling a plurality of primary point clouds and a plurality of secondary point clouds,
assessing the plurality of object profiles determined by the ML engine, and
analyzing errors and updating engine parameters based on feedback.

19. The machine-readable medium, facilitating the method for object detection for detecting the object transiting through the fare gate in the transit system, of claim 16, wherein:
the radar emits the signal at a plurality of incidence angles,
the reflective surface reflects the signal at a plurality of reflection angles, and
the plurality of incidence angles and the plurality of reflection angles affect an electromagnetic response of the reflective surface.

20. The machine-readable medium, facilitating the method for object detection for detecting the object transiting through the fare gate in the transit system, of claim 16, wherein the reflective surface is passive and comprises:
a plurality of copper layers and a substrate in between the plurality of copper layers; and
a plurality of wavelength-related spatially arranged unit-cell patches with a variable geometry in a phase pattern.
